(19) United States
(12) Patent Application Publication
(10) Pub. No.: US 2023/0060580 A1
(43) Pub. Date: Mar. 2, 2023

(54) SYSTEM AND METHOD FOR PASSENGER PLANE TO CARGO PLANE CONVERSION

(71) Applicant: Foxtrot Aero, LLC, Las Vegas, NV (US)

(72) Inventors: Paul David Kraus, Los Angeles, CA (US); Paul Apostolos Bithavas, Camp Hill (AU)

(21) Appl. No.: 17/896,002

(22) Filed: Aug. 25, 2022

Related U.S. Application Data
(60) Provisional application No. 63/236,985, filed on Aug. 25, 2021.

(51) Int. Cl. B64F 5/10; B64C 1/20; B64C 39/02; B64D 9/00; B64D 45/00

(52) U.S. Cl. CPC B64F 5/10; B64C 1/20; B64C 39/02; B64D 9/00; B64D 45/00; B64D 2045/009

(57) ABSTRACT

The present invention is a system and method for modifying a passenger aircraft and converting it for use as a cargo aircraft, wherein the steps include removing all structures that were previously put into the aircraft to accommodate passengers including walls, storage, and seating, wherein the seat tracks are left in the floor to function as secure attachment points, moving pallet sections into the aircraft that can fit through the existing doorways, and assembling the pallet sections together to create pallet assemblies, wherein the pallet assemblies function as a bridging system upon which cargo loads may be disposed without causing damage to the existing unreinforced floor of the aircraft, wherein each of the pallet assemblies is connected to the existing seat tracks in the floor in order to secure the pallet assemblies to the aircraft frame.

### BACKGROUND

Field of the Invention: This invention relates generally to commercial aircraft. More specifically, the invention is directed to the conversion of passenger aircraft to cargo aircraft and facilitating the carriage of increased main deck payload.

Description of Related Art: There are many passenger aircraft that for various reasons sit parked and unused at locations around the world. In contrast, there is a substantial need for commercial cargo aircraft. However, the cost of a new cargo aircraft is substantial and may not be an economically viable option for many cargo carriers.

One option for cargo carriers is to pay for the aircraft manufacturers conversion centers to convert a passenger aircraft to a cargo aircraft. Unfortunately, aircraft manufacturers and passenger-to-cargo conversion companies charge large fees for this conversion. For example, the conversion cost for a modern wide-body aircraft may be on the order of $30 Million or more.

Accordingly, it would be an advantage over the prior art to provide a system and method for conversion of passenger aircraft to cargo aircraft at a substantially reduced cost. It would be a further advantage if the conversion method also minimized the alterations that are made during conversion to keep the conversion costs as low as possible while still meeting the needs of a cargo aircraft.

### BRIEF SUMMARY

The present invention is a system and method for modifying a passenger aircraft and converting it for use as a cargo aircraft, wherein the steps include removing all structures that were previously put into the aircraft to accommodate passengers including walls, storage, and seating, wherein the seat tracks are left in the floor to function as secure attachment points, moving pallet sections into the aircraft that can fit through the existing doorways, and assembling the pallet sections together to create pallet assemblies, wherein the pallet assemblies function as a bridging system upon which cargo loads may be disposed without causing damage to the existing unreinforced floor of the aircraft, wherein each of the pallet assemblies is connected to the existing seat tracks in the floor in order to secure the pallet assemblies to the aircraft frame.

In a first aspect of the invention, multiple pallet sections are disposed a together using a plurality of channels, wherein the channels are secured to the pallet sections and to the seat tracks of the aircraft.

In a second aspect of the invention, top mount anchor fittings or seat tracks are disposed on a top surface of the pallet assemblies to provide a plurality of anchor points for securing loads to the pallet assemblies and to the aircraft structure.

In a third aspect of the invention, the existing aircraft doors may be increased in height or altered in order to accommodate larger loads within the aircraft or to facilitate the loading of cargo.

These and other embodiments of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a perspective view of the prior art showing a seat track and a leg of a seat coupled to the seat track.

FIG. 2 is a top view of the inside of the fuselage of an aircraft being converted from a passenger aircraft to a cargo aircraft and showing a cargo compartment and a modified crew compartment.

FIG. 3 is a close-up top view of the modified crew compartment.

FIG. 4 is a top view of a portion of the cargo compartment and showing the seat tracks that are left in the floor of the new cargo compartment.

FIG. 5 is a perspective view of three pallet sections disposed adjacent to each other to create a pallet assembly that is secured to the existing seat tracks in order to spread the weight of cargo.

FIG. 6 is a top view of a portion of the cargo compartment that shows the placement of pallet assemblies relative to the seat tracks in order to maximize cargo carrying capacity while providing access to all sides of the cargo.

FIG. 7 is a top view of the three separate pallet sections and showing placement of the top mount seat tracks that form attachment points for cargo nets to secure loads to the pallet assemblies.

FIG. 8 is a bottom view of the same three separate pallet sections and showing placement of the attachment points that are coupled to the seat tracks in the floor of the cargo compartment.

FIG. 9 is a close-up perspective view of a portion of a pallet assembly.

FIG. 10A is a top view of a pallet assembly.

FIG. 10B is a profile view of the pallet assembly showing attachment channels that protrude from the bottom of the pallet assembly.

FIG. 10C is a close-up view of a corner of the top surface of a pallet assembly showing detail of the top mount seat tracks.

FIG. 10D is a top view of the Hat channel track 56 that is used to create the pallet assembly from the three pallet sections.

FIG. 10E is a close-up view of the Hat channel track shown in FIG. 10D.

FIG. 10F is a close-up and cross-sectional view of the Hat channel track showing a bolt.

FIG. 11 is a top view of the cargo compartment in an aircraft showing a possible arrangement of pallet assemblies to maximize cargo carrying capacity.

FIG. 12 is a cross-sectional view of the inside of the cargo compartment and showing two pallet assemblies with cargo loads disposed thereon.

FIG. 13 is a profile view of the aircraft with an additional door flap to provide access for larger cargo loads.

### DETAILED DESCRIPTION

Reference will now be made to the drawings in which the various embodiments of the present invention will be discussed so as to enable one skilled in the art to make and use the invention. It is to be understood that the following description illustrates embodiments of the present invention and should not be viewed as narrowing the claims which follow.

There may be substantial differences between a passenger aircraft and a cargo aircraft. These differences include structural differences that make an aircraft suitable for passengers but not suitable for high cargo loads and their required restraint systems. For example, access to a passenger aircraft is typically provided through a relatively small doorway. In contrast, cargo aircraft typically have a larger doorway that enables larger loads to be moved in and out of the aircraft more conveniently.

Another relevant structural difference may be attributed to the load bearing capacity of the pressurized compartment within an aircraft. While cargo loads are typically heavier than passengers for a given amount of floor space, passenger aircraft are not configured for handling the larger or distributed loads of cargo because passengers and their seats are typically lighter or confined to a smaller footprint.

In summary, commercial passenger aircraft are typically designed and certified to carry a particular type of load that may be defined as point loads and density through the seat tracks and into the aircraft structure. Point loads of passenger aircraft may therefor create a load limitation because of the inherent design, which is primarily based on the requirements of, but not limited to, passenger seats, passengers, and various lightweight cabin structures.

The present invention introduces a supplementary structure that can be readily installed, removed, and quickly reconfigured in a converted passenger aircraft to enhance the load carrying capability and configuration options of a cargo aircraft.

The prior art describes the cost of the conversion by aircraft manufacturers. One of the reasons for the high cost is that to increase the load carrying capability required for the carriage of heavier freight loads, it is common to modify the pre-existing passenger aircraft structure to strengthen the affected cargo carrying areas. However, this typically requires a permanent and costly modification to the aircraft structure. Accordingly, one of the advantageous aspects of the present invention is the ability to convert passenger aircraft to cargo aircraft in a manner that does not require costly modification of existing aircraft structure.

Thus, the first embodiment of the invention requires fewer and less expensive modifications to a passenger aircraft. The first step in the process of conversion in the first embodiment of the invention is to remove a substantial portion of the existing structure that is typically present in the passenger compartment of a passenger aircraft. The extent to which the structure is removed may depend upon the specific requirements of the customer. While most of the structure is removed, there may be some structure that is left in place, such as selected lavatories.

More specifically, the structural items removed include but are not limited to, overhead luggage bins, kitchen galleys, lavatories, closets, carpet, cabin monuments, and all of the passenger seating from the proposed cargo compartment. Other items may include flooring materials that have been put down over the basic floor structure of the passenger compartment, and an inner wall of the aircraft. In the first embodiment, insulation disposed between the inner wall and an outer wall of the aircraft is left intact.

Importantly and advantageously, one item that is not removed or substantially modified from the proposed cargo compartment are the seat tracks. Seat track is commonly installed on the floor of the passenger compartment allowing passenger seats and other cabin monuments to be attached to the seat track rather than directly to the floor beams, panels or other aircraft structure. This allows for secure attachment of the seats and other cabin monuments, providing the option of moving or removing these items quickly and simply by removing them from the seat tracks as needed. Seat tracks are typically anchored directly or indirectly to the structure of the aircraft and thus form inherently strong attachment points and are a structural load carrying element of the aircraft structure (with inherent load carrying limitations).

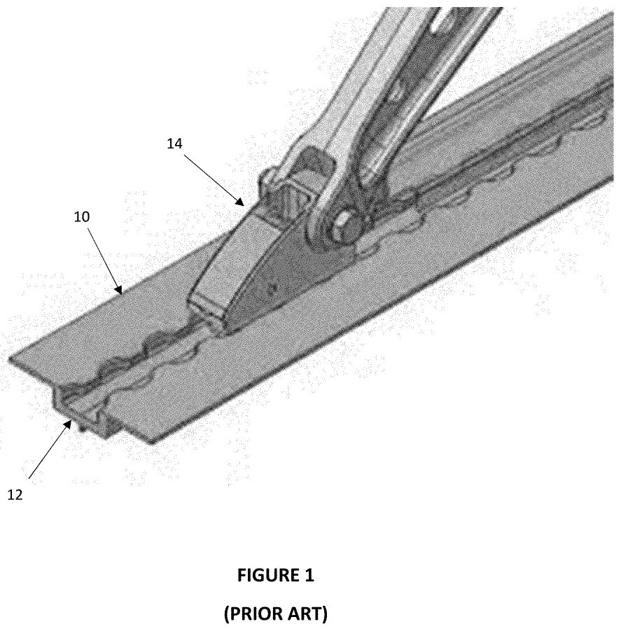

FIG. 1 is a perspective view of typical seat track 10 in the prior art. The seat track 10 is attached to an existing passenger compartment by bolts (not shown) that are disposed through the bottom of a groove or channel 12 into the floor structure. The seat track 10 is shown with a leg portion 14 of a passenger seat shown disposed into the channel 12. The leg portion 14 would include any necessary hardware to lock itself into the channel 12 so that it could not slide along the channel after installation.

The first embodiment of the invention removes most or all of the structures that are put into the aircraft for flight attendants to use when taking care of passengers. However, pilot seating will remain intact as may a few seats in front of a smoke barrier that may be disposed between the pilot area and the cargo area. Removed structures include storage areas for food and lockers for passenger items such as coats and other odd sized items. This may also include lavatories at various locations within the fuselage, with at least one lavatory remaining intact for pilot and crew (if any).

While obvious structural elements for passenger comfort and care are removed, other structural items that may be removed include the inner compartment walls that typically cover the insulation between the inner and outer walls. Passenger compartments may also include overhead baggage bins, ceiling structures that hide hoses for oxygen masks, ductwork used for routing air to passenger seats, and wiring for lights, in-flight entertainment systems, and various other passenger accommodation requirements.

However, some of these existing structures on the walls and in the ceiling may be left intact if they are useful for the customer and do not interfere with the installation of the pallet assemblies and cargo.

Essentially, the passenger area may be stripped bare. All modifications to the aircraft at this point are to remove all of the items that are installed to sustain passengers. This is all seating, food preparation and storage areas, general and overhead stowage, passenger and cabin crew emergency equipment, and ductwork for carrying air to all passenger areas of the aircraft. However, it should be understood that while most passenger area ductwork will be removed, some of the ductwork may just be modified for the cargo area.

It should be noted that the cockpit and any supporting structure is not removed or modified. Essentially, all that is left of the passenger compartment is a bare floor and wall framing with insulation. Passenger lavatories may also be removed, while leaving at least one lavatory for the pilots and crew near the cockpit.

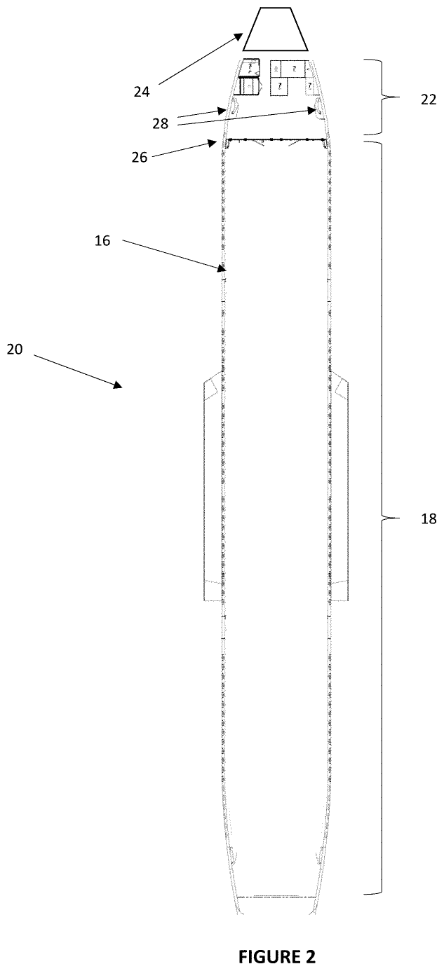

FIG. 2 is a top view of the inside of the fuselage 16 of the aircraft 20 showing the cargo compartment 18, a crew compartment 22, a cockpit 24, and two doors 28. In this figure, the interior of the cargo compartment 18 has had all structures removed to leave a bare floor. However, it is important to understand that the existing seat tracks 10 are still in the floor and have not been removed from the cargo compartment 18.

FIG. 2 also shows that a smoke barrier 26 has been disposed between the crew compartment 22 and the cargo compartment 18. The smoke barrier 26 is a safety feature that prevents smoke from a fire in the cargo compartment 18 from reaching the crew compartment 22 for as long as possible.

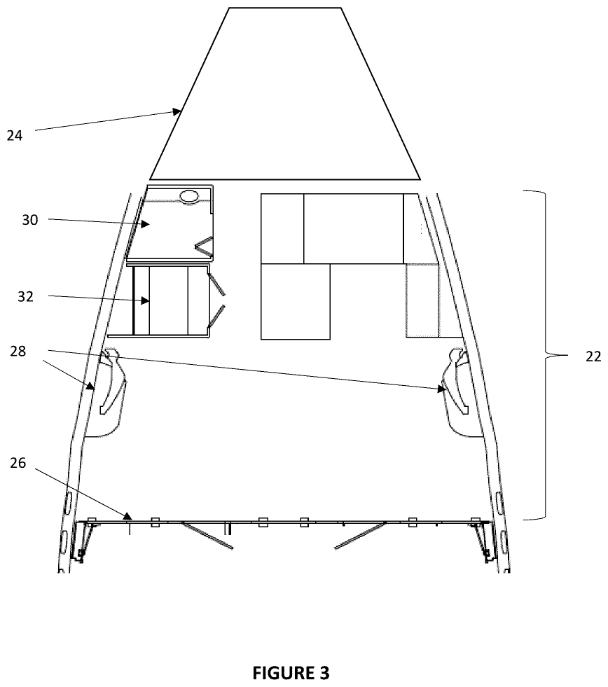

FIG. 3 is a top and close-up view of the crew compartment 22, the cockpit 24, the doors 28, and the smoke barrier 26. The structures that remain in the crew compartment 22 may include any structures that are requested by the client. The remaining structures in the crew compartment 22 may be selected from the list of possible structures including a lavatory 30, a closet 32, extra seating, food storage, utility closets, etc. What is important is that these structures are disposed in the crew compartment 22 and not in the cargo compartment 18 in order to maximize space that is available for cargo.

It is noted that the doors 28 in the crew compartment 22 are the original doors of the aircraft 20. The doors 28 have not been modified in any way in the first embodiment of the invention.

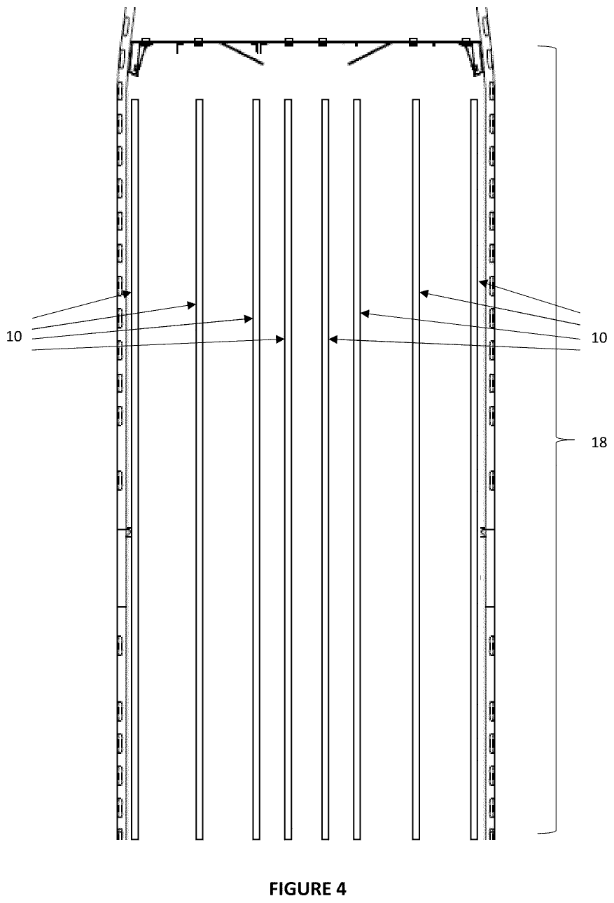

FIG. 4 is a close-up view of a portion of the cargo compartment 18. This figure is provided in order to illustrate the seat tracks 10 that are disposed on the floor of the cargo compartment 18. It is noted that the seat tracks may be continuous from the front of the cargo compartment 18 all the way to the back. The advantage of such a configuration is that the bridging system to be shown can be disposed anywhere along the length of the seat tracks 10 and sized to accommodate specific operational and aircraft requirements.

Because of the design of some passenger aircraft, the original seat tracks 10 may not be continuous from the front of the cargo compartment all the way to the rear. In this situation, seat tracks 10 may need to be installed in order to obtain the desired continuous seat track 10 through the entire cargo compartment.

It is noted that the spacing between the seat tracks 10 may not be uniform. However, this spacing is a function of the existing seat tracks 10 in the passenger aircraft that are being converted by the present invention. However, it does not matter if the seat tracks 10 have uniform spacing or not, as the bridging system may be manufactured to match the seat tracks 10 spacing of any aircraft.

The next step in the first embodiment of the invention is to add a minimal amount of structure to the cargo compartment 18 to enable cargo that is heavier or of a different load distribution (direct load and/or for load restraint) than passengers to be supported by the existing floor. However, instead of adding permanent and expensive structural reinforcement to the floor, an important aspect of the first embodiment of the invention is to add a bridging system to compensate for any lack of reinforcement. This aspect of the invention may result in a substantial cost savings in the conversion process and complexity of the structure for operational and maintenance purposes.

It is noted that by using the existing seat tracks 10, in conjunction with the invention, the capacity for total load are increased. While the point loads are unchanged, the loads are spread over the span of seat tracks 10 that are covered by a pallet assembly. Advantageously, the bridging system is installed without making any permanent changes to the floor in the cargo compartment 18. Thus, reconfiguration of the cargo compartment 18 is as easy as moving the bridging system as will be shown.

Another aspect of the first embodiment is that additional seat tracks 10 may be installed or replaced to suit specific aircraft variances. By using existing structural hardpoints of the aircraft frame or floor beams, no modification of the frame is possible.

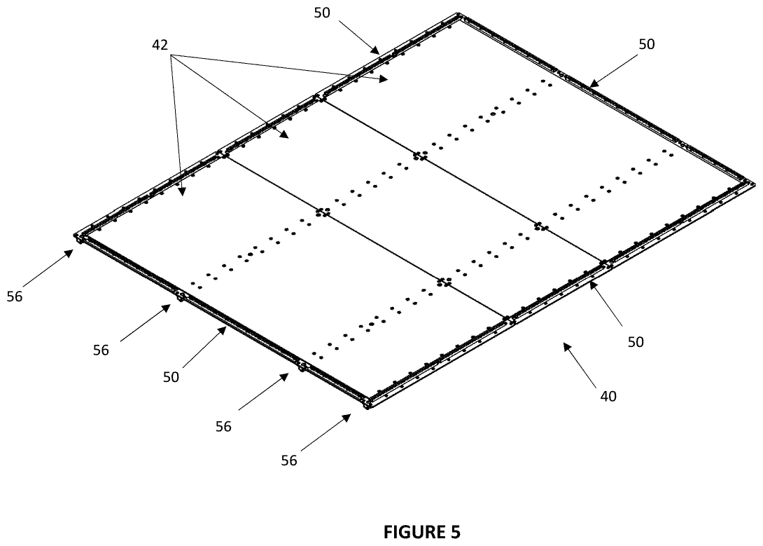

FIG. 5 is a perspective view of a bridging system in the form of a pallet assembly 40. The pallet assembly 40 may be comprised of one or more pallet sections 42, channel tracks 56, and top mount seat tracks 50 around a perimeter that all together form a single pallet assembly 40. The first embodiment shown in FIG. 5 shows the pallet assembly 40 may be comprised of three pallet sections 42 that are disposed adjacent but not physically connected to each other to form the single pallet assembly 40. However, it should be understood that the number of pallet sections 42 that are used to construct a single pallet assembly 40 may be modified as the need arises. Accordingly, the pallet assembly 40 should be understood to be comprised of one or more pallet sections 42.

One of the purposes of dividing the pallet assembly 40 into multiple pallet sections 42 is to avoid having to increase the size of a door into the aircraft 20. In other words, each pallet section 42 of the pallet assembly 40 will fit through the existing door of the aircraft 20. Then the pallet sections 42 may be brought together to form a larger pallet assembly if necessary, and in a manner to be explained to form the pallet assembly 40. However, it should be understood that a pallet assembly may be comprised of a single pallet section.

One advantage of having a pallet assembly comprised of multiple pallet sections is that if any of the pallet sections are damaged, the damaged pallet section may simply be removed and replaced.

The bridging system may be comprised of any high load bearing materials. These materials include such things as metal, fiberglass, composites, plastic, some types of hardened rubber, or any other materials with suitable load bearing properties.

The pallet sections 42 may also use structural shapes that increase the load bearing strength of the high load bearing materials. For example, the pallet sections 42 may have an internal honeycomb structure using the high load bearing materials, or use various extrusions to add strength.

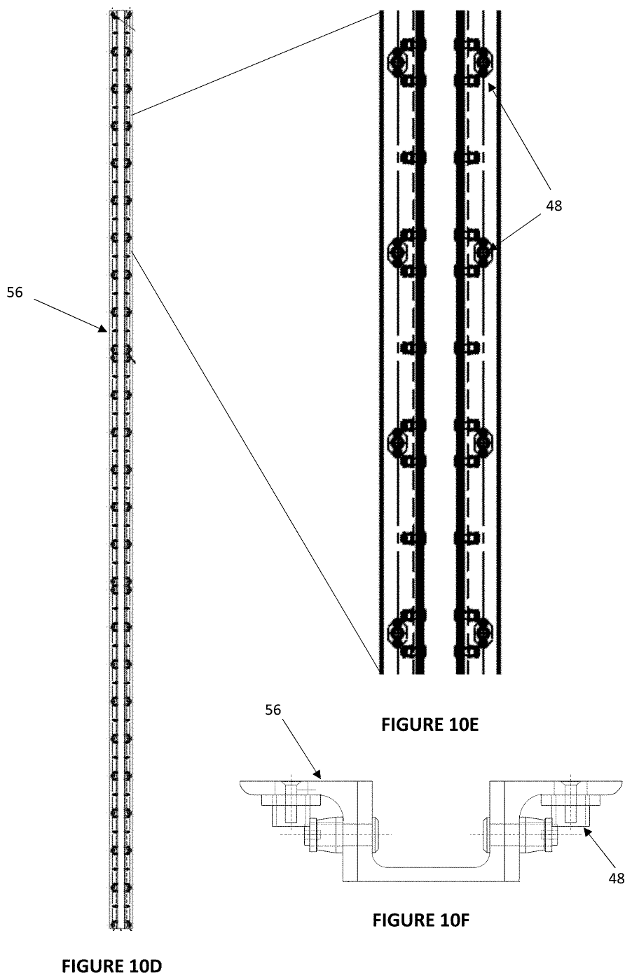

The bridging system may be envisioned as a frame, platform or pallet structure that is mounted on the seat tracks 10 such as shown in FIG. 5. However, there must be some structure on the pallet sections 42 that may be attached to the seat tracks 10. FIG. 5 illustrates this concept by showing that the pallet assembly 40 is shown as having four Hat channel tracks 56 such as shown in cross-section in FIG. 10F. The four Hat channel tracks 56 may each be constructed from a single piece of metal and may be attached to the pallet sections 42 and hold the pallet sections together. Attachment may be accomplished using bolts, rivets or any similar attachment device. While the first embodiment has selected a Hat channel shape, other channel shapes or profiles may be used as necessary to accommodate the specific operational capability or aircraft requirements.

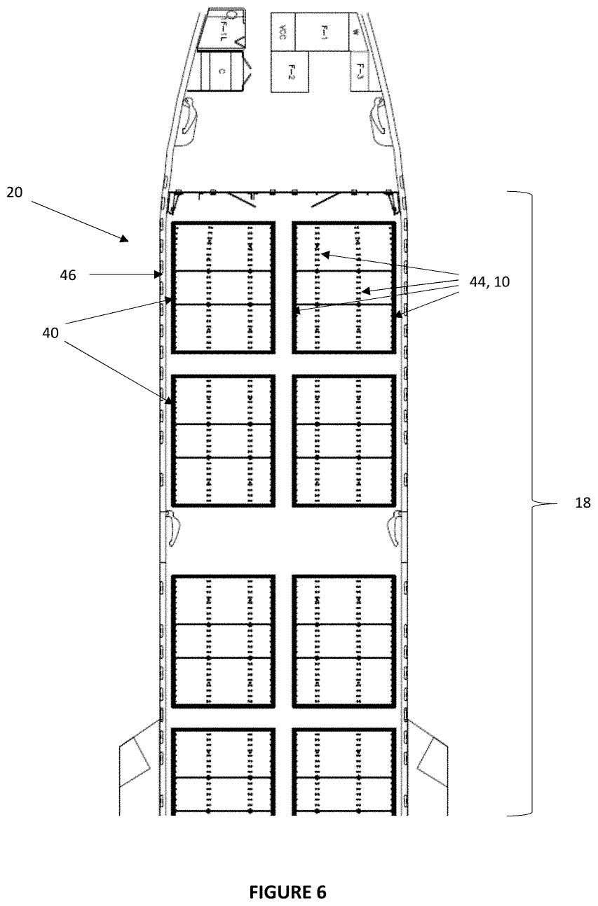

FIG. 6 is a top view of a portion of the aircraft 20 which shows a plurality of bridging systems or pallet assemblies 40 disposed on the floor of the cargo compartment 18. The seat tracks 10 in the floor are covered by the pallet assemblies 40 but their locations are indicated by the dash marks 44. The dash marks 44 on the edges of the pallet assemblies 40 are partially obscured but are indicated by the arrows. It is noted that the seat tracks 10 are still in the floor between the pallet assemblies but are not shown in this figure.

The pallet assemblies 40 are shown as being close to the walls 46 of the aircraft 20, but with sufficient space between the walls 46 and the pallet assemblies 40 and the pallet assemblies themselves to enable a person or mechanism to maneuver between them. In this way, it may always be possible to secure the cargo to the pallet assemblies 40 using a cargo net and make periodic checks or adjustments as needed.

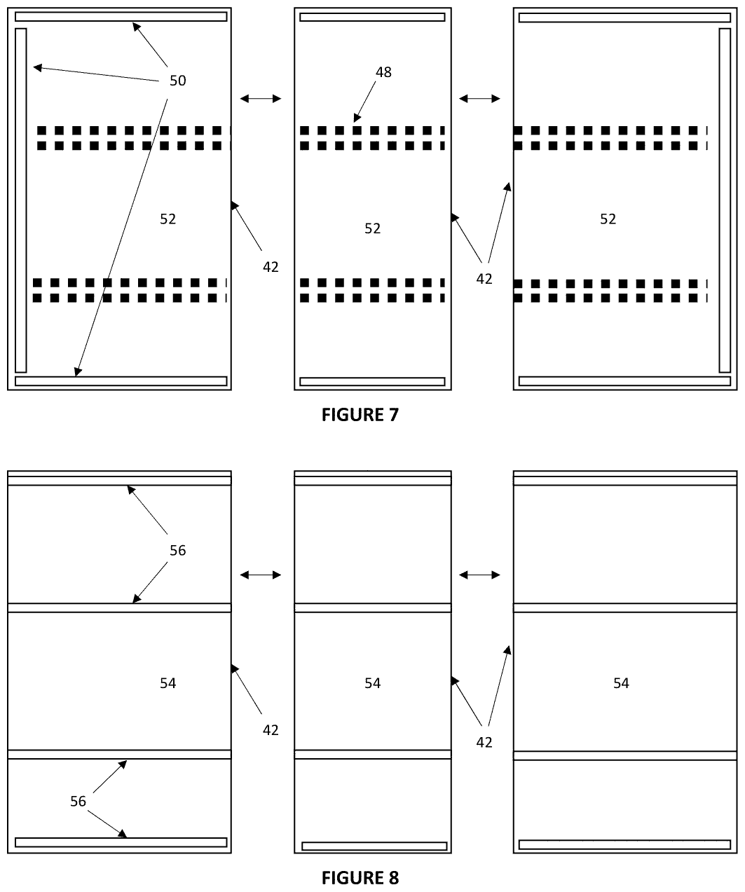

FIG. 7 is a top view of the top surfaces 52 of the three pallet sections 42 that may be brought together to form the single pallet assembly 40. The top view illustrates that the pallet sections 42 have cargo attachment means around the outer edges disposed on top of each pallet section 42. In the first embodiment, these cargo attachment means may be top mount seat tracks 50. In other words, even though the pallet sections 42 are attached to seat tracks 10 on a bottom surface 54, the top surface 52 of the pallet assemblies 40 are equipped with top mount seat tracks 50 that provide attachment points all around a perimeter.

For example, the pallet assemblies 40 may secure cargo to the top surface using cargo nets (not shown). The cargo nets may be secured to the pallet assemblies 40 by using attachment points provided by the top mount seat tracks 50 disposed on the top surface 52. Use of the top mount seat tracks 50 also provides attachment points along their entire length, and thus provide maximum flexibility for the placement and securing of loads to the pallet assembly 40. In other words, the distribution of the forces on the cargo loads and the pallet assembly 40 may be balanced for a variety of different load configurations.

While the top mount seat tracks 50 are a convenient system for providing multiple attachment points for cargo nets in the first embodiment, it should be understood that any cargo attachment system may be substituted for the top mount seat tracks 50 disposed around the pallet assemblies 40.

The dotted lines on each of the pallet sections 42 indicate the attachment points 48 that are used to attach the pallet sections to the Hat channel tracks 56 on the bottom surface 54 of the pallet sections. It is noted that while the bolts 48 may be used to secure the Hat channel tracks 56 to the pallet sections 42, any adequate means of securing them may also be used. For example, these alternate securing means may be rivets or any other adequate fastening device.

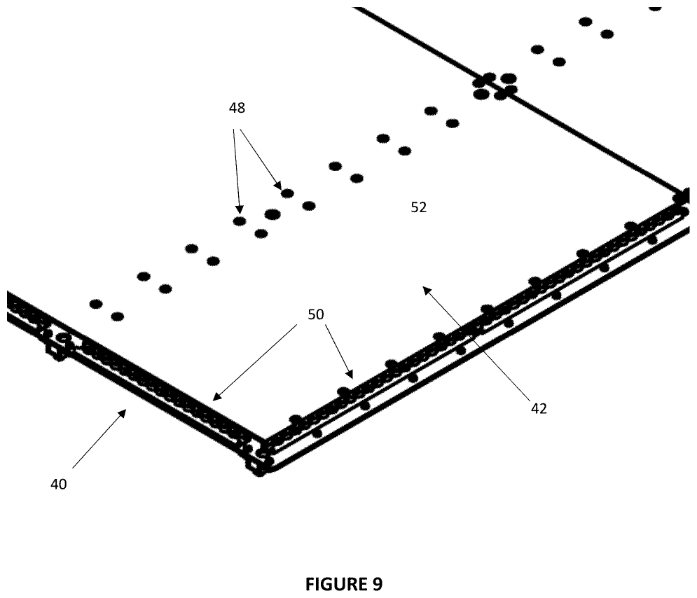

FIG. 8 is a bottom view of the pallet sections 42 and illustrate the bottom surfaces 54 thereof. The Hat channel tracks 56 are shown as being separate on each of the pallet sections 42, but this is for illustration purposes only. Each of the four Hat channel tracks 56 is a single piece of metal and structurally hold the pallet sections 42 together. The Hat channel tracks 56 may be coupled to the seat tracks 10 in any convenient manner as is known in the industry.

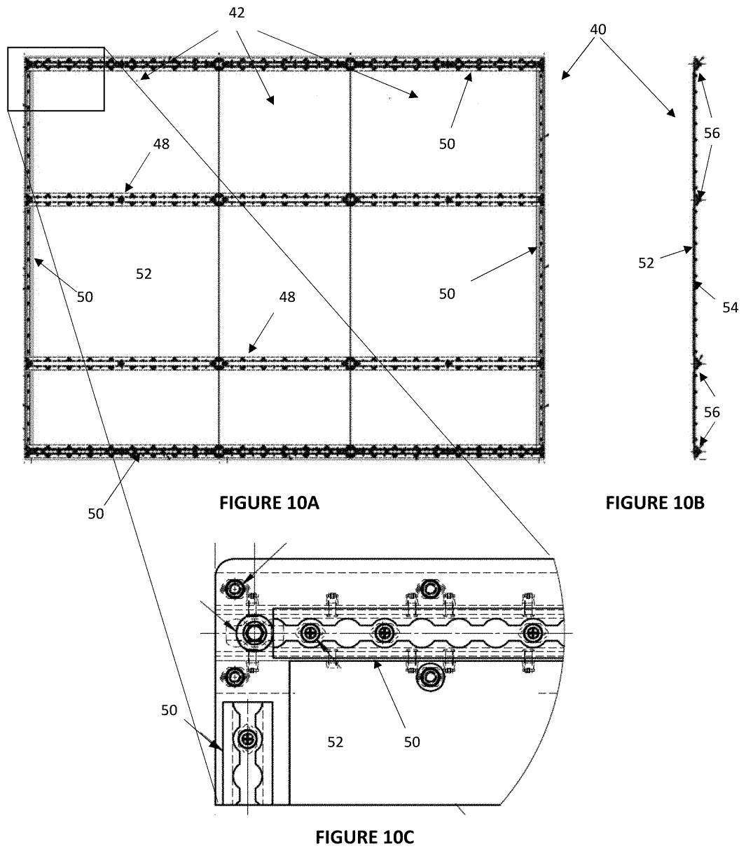

FIG. 9 is a close-up view of a corner of the pallet assembly 40 shown in the perspective view in FIG. 5. In this perspective view of the top surface 52, this figure shows the bolts 48 that attach the Hat channel tracks 56 underneath to each of the pallet sections 42. Also shown are the top mount seat tracks 50 that are disposed around the perimeter of the pallet assembly 40 and which form the attachment points for cargo nets.

FIG. 10A is provided as a top view of the pallet assembly 40 shown in FIGS. 5, 7, and 9. The top surface 52 of the pallet assembly 40 includes the top mount seat tracks 50 on all four edges that function as the attachment points for the cargo nets. The figure also shows the bolts 48 for coupling the Hat channel tracks 56 to the pallet assembly 40. The Hat channel tracks 56 may be seen through the pallet sections 42 in this figure for illustration purposes only.

FIG. 10B is provided as a profile view of the pallet assembly 40 of FIG. 10A. This view is provided to illustrate the Hat channel tracks 56 that extends outward from the bottom surface 54 of the pallet assembly 40 and attach to the seat tracks 10.

FIG. 10C is provided as a close-up top view of a corner of a single pallet section 42. This corner shows detail regarding the top mount seat tracks 50 that are disposed on the top surface 52 of the pallet sections 42.

FIG. 10D is a top view of the Hat channel track 56 that is used to create the pallet assembly 40 from the three pallet sections 42.

FIG. 10E is a close-up view of the Hat channel track 56 shown in FIG. 10D.

FIG. 10F is a close-up and cross-sectional view of the Hat channel track 56 showing a bolt 48.

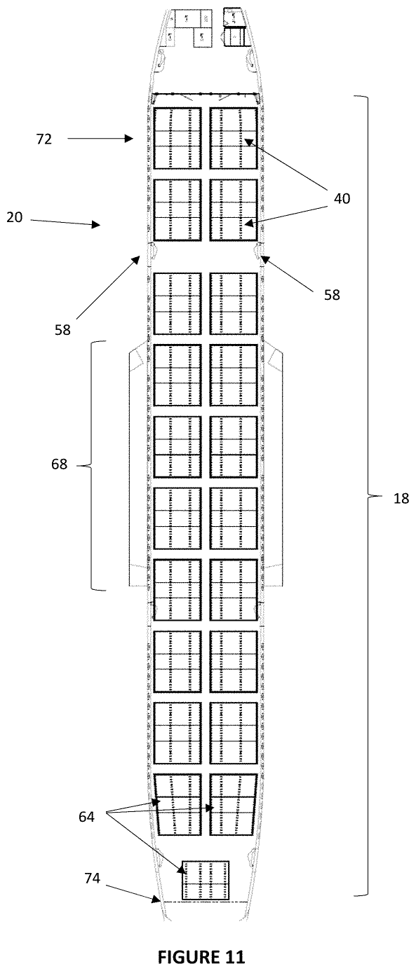

FIG. 11 is a top view of the aircraft 20 that illustrates that an important aspect of the first embodiment of the invention is the placement of the pallet assemblies 40 within the cargo compartment 18. FIG. 11 shows the front of the aircraft 20 at the top of the figure. This figure shows that in the first embodiment of the invention, a total of 21 pallet assemblies 40 may be disposed on the floor of the aircraft 20. The pallet assemblies 40 may be thought of as being in rows or zones 72. In this first embodiment, there are 11 zones of pallet assemblies.

This layout also shows that there is space on all four sides of the pallet assemblies 40. This access may be crucial in order to secure the loads to the pallet assemblies 40 using cargo nets that are disposed over the loads and then secured to the top mount seat tracks 50.

Not all of the pallet assemblies 40 are the exact same size and shape. In this first embodiment, three pallet assemblies 64 at the rear of the aircraft 20 are modified in shape in order to fit within the available dimensions of the narrowing cargo compartment 18. It is also noted that a wider space is left between pallet assemblies 40 near the front of the aircraft 40 where cargo doors 58 are located so that the cargo doors are not blocked.

After experimentation, it has also been determined that pallet assemblies near a front end of the cargo compartment 18 may require modification because of narrow aircraft design at the front of the aircraft 20. A modification to pallet assemblies may also be required over the wing box joint areas 68 as shown in FIG. 11. This is because of the required flexibility of the aircraft 20 at the wing box joint when in flight.

FIG. 11 also shows an aft barrier wall 74 at the back of the cargo compartment. This aft barrier wall 74 may be used to separate the cargo compartment or protect a pressure hull.

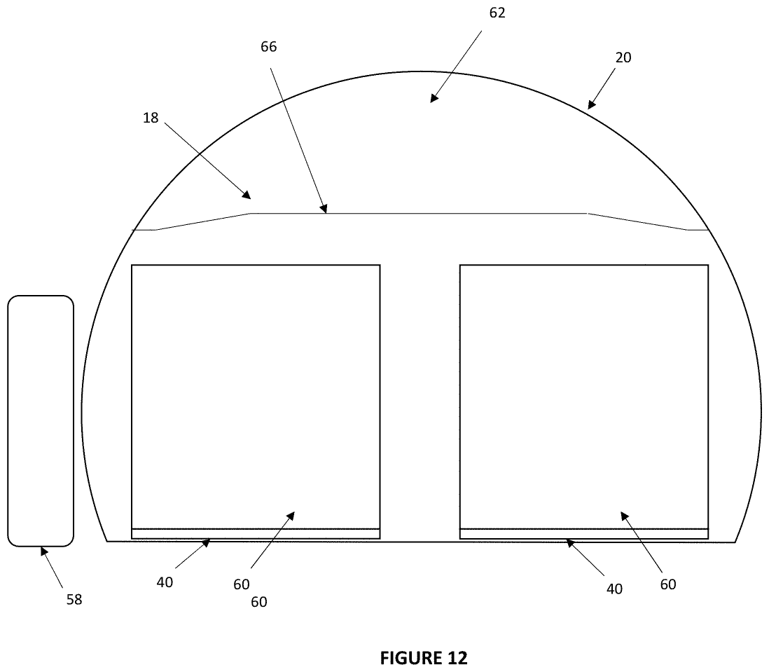

FIG. 12 is a cut-away profile view of the inside of the cargo compartment 18 of the aircraft 20 along a long axis. In other words, the view is from inside the cargo compartment 18 and looking from, for example, the front end of the aircraft 20 and toward the rear end. This figure shows two pallet assemblies 40, each with a cargo load 60 disposed thereon. More importantly, this figure shows the height of the cargo loads 60 on the pallet assemblies 40 relative to the height of the door 58. In this first embodiment, the cargo loads 60 may be higher than the height of the door 58, which only limits the size of the objects that may be brought into the cargo compartment.

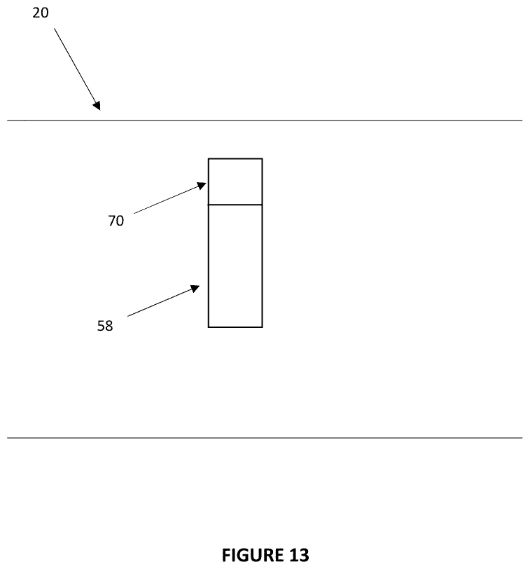

However, in a second embodiment of the invention, the height or other features of the door 58 may be increased or changed. This is not a temporary but a permanent structural modification to the aircraft 20 to accommodate larger objects. This is illustrated in FIG. 13 in a profile view of the outside of the aircraft 20 at the door 58. One modification that can be made to the door 58 is the use of a door flap 70 which is a limited modification of the aircraft 20. Instead of replacing the door, an additional door 70 is installed directly above the existing door 58. The entrance to the aircraft 20 is now whatever height is added to the existing door with the additional door 70.

FIG. 12 also shows that there are structures 66 on the ceiling forming a headspace 62. These structures 66 may include railing, support structures, lighting and ductwork. However, if these structures 66 are moved within or removed from the ceiling, the ceiling may be made higher within the cargo compartment 18.

It is noted that an added feature of the first embodiment allows the option to not install a 9G Bulkhead as is typical in large cargo aircraft. This further reduces the price of the conversion of the aircraft. Instead of having a 9G wall, 9G individual nets are used to secure the loads for each pallet assembly 40.

In summary, the first embodiment of the present invention may be described as a method for converting a passenger aircraft to a cargo aircraft, said method comprising the steps of 1) removing structures from the aircraft that are provided for passenger use in a passenger compartment to thereby create a cargo compartment, 2) stripping all floor covering material off of a floor and exposing seat tracks that are not removed from the floor, wherein the seat tracks extend a length of the cargo compartment, 3) installing a smoke barrier between the cargo compartment and a front end of the aircraft, wherein the front end is designated as a crew compartment and includes a cockpit, 4) providing a plurality of pallet assemblies for carrying cargo, wherein the pallet assemblies are coupled to the seat tracks, wherein the pallet assemblies are spaced apart to enable access to the plurality of pallet assemblies, and 5) wherein the floor is not reinforced but keeps a same structure that was created for the passenger aircraft, and wherein the plurality of pallet assemblies distributes weight of cargo over the seat tracks.

Furthermore, the first embodiment of the present invention may also be described as a system for converting a passenger aircraft to a cargo aircraft, said system being comprised of a cargo compartment disposed at a rear portion of the cargo aircraft, a crew compartment disposed at a front portion of the cargo aircraft, wherein the crew compartment includes a cockpit, a plurality of seat tracks disposed in a floor of the cargo compartment, wherein the seat tracks are disposed in parallel to each other and extending a length of the cargo compartment, a plurality of pallet assemblies for carrying cargo, wherein the pallet assemblies are coupled to the seat tracks, wherein the pallet assemblies are spaced apart to enable access to the plurality of pallet assemblies, and wherein the floor of the cargo compartment is not reinforced but keeps a same support structure as when the cargo compartment was used as a passenger compartment.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. It is the express intention of the applicant not to invoke 35 U.S.C. § 112, paragraph 6 for any limitations of any of the claims herein, except for those in which the claim expressly uses the words ‘means for’ together with an associated function.

What is claimed is:

1. A method for converting a passenger aircraft to a cargo aircraft, said method comprising:
removing structures from the aircraft that are provided for passenger use in a passenger compartment to thereby create a cargo compartment;
stripping flooring material off of a floor and exposing seat tracks that are not removed from the floor, wherein the seat tracks extend a length of the cargo compartment;
installing a smoke barrier between the cargo compartment and a front end of the aircraft, wherein the front end is designated as a crew compartment and includes a cockpit;
providing a plurality of pallet assemblies for carrying cargo, wherein the pallet assemblies are coupled to the seat tracks, wherein the pallet assemblies are spaced apart to enable access to the plurality of pallet assemblies; and
wherein the floor is not reinforced but keeps a same structure that was created for the passenger aircraft, and wherein the plurality of pallet assemblies distributes weight of cargo over the seat tracks.

2. The method as defined in claim 1 wherein the method of providing the plurality of pallet assemblies for carrying cargo further comprises:
Providing at least two pallet sections having a top surface and a bottom surface;
moving the at least two pallet sections through a door and into the cargo compartment;
assembling the at least two pallet sections to make a pallet assembly by disposing the three pallet sections in a row, wherein the at least two pallet sections are rectangular and have a same length, wherein the at least two pallet sections are disposed adjacent to each other to form a large rectangle;
providing at least two Hat channel tracks of same length, wherein the lengths of the at least two Hat channel tracks are equal to a width of the pallet assembly; and
attaching the at least two Hat channel tracks to the pallet assembly in parallel and across the width of the pallet assembly to thereby form a rigid pallet assembly.

3. The method as defined in claim 2 wherein the method of providing the plurality of pallet assemblies for carrying cargo further comprises:
disposing the pallet assembly on the seat tracks of the cargo compartment such that the four Hat channel tracks are directly over four seat tracks; and
attaching the at least two Hat channel tracks to the seat tracks to thereby attach the pallet assembly to the floor of the cargo compartment.

4. The method as defined in claim 3 wherein the method of providing the plurality of pallet assemblies for carrying cargo further comprises:
providing a plurality of top mount seat tracks; and
attaching the plurality top mount seat tracks on the top surface of the pallet assembly such that the plurality of top mount seat tracks is disposed around a perimeter of the pallet assembly.

5. The method as defined in claim 4 wherein the method of providing the plurality of pallet assemblies for carrying cargo further comprises:
disposing the cargo on the plurality of pallet assemblies;
providing a plurality of cargo nets; and
securing the cargo to the plurality of pallet assemblies using the plurality of cargo nets, wherein the plurality of cargo nets is secured to the top mount seat tracks on each of the pallet assemblies.

6. The method as defined in claim 5 wherein the method of providing the plurality of pallet assemblies for carrying cargo further comprises:
disposing at least one zone of pallet assemblies in the cargo compartment; and
spacing the pallet assemblies such that there is room to access the pallet assemblies from all four sides.

7. The method as defined in claim 6 wherein the method of providing the plurality of pallet assemblies for carrying cargo further comprises:
detaching the plurality of pallet assemblies from the seat tracks;
moving the plurality of pallet assemblies into a different desired layout; and
reattaching the plurality of pallet assemblies into the desired layout.

8. The method as defined in claim 7 wherein the method of converting a passenger aircraft to a cargo aircraft further comprises:
removing an existing door and door frame from the aircraft;
creating a larger door frame where the door frame was removed; and
installing a larger door in the larger door frame to thereby enable larger cargo to be transported by the aircraft.

9. The method as defined in claim 7 wherein the method of converting a passenger aircraft to a cargo aircraft further comprises installing an additional door flap above the door to thereby increase a size of an entrance into the aircraft without removing the door and to thereby enable larger cargo to be transported by the aircraft.

10. The method as defined in claim 1 wherein the method of converting a passenger aircraft to a cargo aircraft further comprises removing structures from the passenger compartment, wherein the removed structures are selected from a list of structures comprised of passenger seats, overhead luggage bins, kitchen galleys, lavatories, an inner aircraft wall, insulation, carpet, and closets.

11. The method as defined in claim 1 wherein the method of converting a passenger aircraft to a cargo aircraft further comprises adding additional seat tracks to a floor of the cargo compartment where no seat tracks were originally installed.

12. A system for converting a passenger aircraft to a cargo aircraft, said system comprised of:
a cargo compartment disposed at a rear portion of the cargo aircraft;
a crew compartment disposed at a front portion of the cargo aircraft, wherein the crew compartment includes a cockpit;
a plurality of seat tracks disposed in a floor of the cargo compartment, wherein the seat tracks are disposed in parallel to each other and extending a length of the cargo compartment;
a plurality of pallet assemblies for carrying cargo, wherein the pallet assemblies are coupled to the seat tracks, wherein the pallet assemblies are spaced apart to enable access to the plurality of pallet assemblies; and
wherein the floor of the cargo compartment is not reinforced but keeps a same support structure as when the cargo compartment was used as a passenger compartment.

13. The system as defined in claim 12 wherein the system is further comprised of a smoke barrier disposed between the cargo compartment and the crew compartment to contain smoke within the cargo compartment if smoke is present.

14. The system as defined in claim 12 wherein the plurality of seat tracks disposed in the floor of the cargo compartment are further comprised of two sets of four seat tracks, wherein a first set is disposed on a right side of the cargo compartment, and wherein a second set is disposed on a left side of the cargo compartment.

15. The system as defined in claim 14 wherein each of the plurality of pallet assemblies are coupled either to the first set or to the second set of four seat tracks in order to secure each of the plurality of pallet assemblies to the floor of the cargo compartment.

16. The system as defined in claim 15 wherein the system is further comprised of:
three pallet sections having a top surface and a bottom surface, wherein the three pallet sections are rectangular and have a same length, wherein the three pallet sections are butted against each other to form the pallet assembly in the shape of a large rectangle;
four Hat channel tracks of same length, wherein the lengths of the four Hat channel tracks are equal to a width of the pallet assembly; and
the four Hat channel tracks attached to the pallet assembly in parallel and across the width of the pallet assembly to thereby form the pallet assembly.

17. The system as defined in claim 16 wherein the system is further comprised of four top mount seat tracks that are attached to the top surface of the pallet assembly such that the four top mount seat tracks are disposed around a perimeter of the pallet assembly.

18. The system as defined in claim 17 wherein the system is further comprised of a plurality of cargo nets that are used to secure the cargo to the plurality of pallet assemblies, wherein the plurality of cargo nets is disposed over the cargo on the pallet assemblies and secured to the top mount seat tracks.

19. The system as defined in claim 18 wherein the system is further comprised of at least one zone of pallet assemblies in the cargo compartment, wherein the pallet assemblies are spaced apart such that there is room to access the pallet assemblies from all four sides.

20. A method for converting a passenger aircraft to a cargo aircraft, said method comprising:
removing structures from the aircraft that are provided for passenger use in a passenger compartment to thereby create a cargo compartment;
stripping all flooring material off of a floor and exposing seat tracks that are not removed from the floor, wherein the seat tracks extend a length of the cargo compartment;
installing a smoke barrier between the cargo compartment and a front end of the aircraft, wherein the front end is designated as a crew compartment and includes a cockpit;
providing a plurality of pallet assemblies for carrying cargo, wherein the pallet assemblies are coupled to the seat tracks, wherein the pallet assemblies are spaced apart to enable access to the plurality of pallet assemblies;
wherein each of the plurality of pallet assemblies is comprised of a plurality of pallet sections that are able to fit through an existing door into the cargo compartment, wherein the plurality of pallet sections is then assembled to form the pallet assemblies using Hat channel tracks on a bottom side, wherein the Hat channel tracks are then attached to the seat tracks; and
wherein the floor is not reinforced but keeps a same structure that was created for the passenger aircraft, and wherein the plurality of pallet assemblies distributes weight of cargo over the seat tracks.
